(19) United States
(12) Patent Application Publication
(10) Pub. No.: US 2022/0396977 A1
(43) Pub. Date: Dec. 15, 2022

(54) Quick Physical Restraint System

(71) Applicant: Thomas L. Gimbel, Manahawkin, NJ (US)

(72) Inventor: Thomas L. Gimbel, Manahawkin, NJ (US)

(21) Appl. No.: 17/689,732

(22) Filed: Mar. 8, 2022

Related U.S. Application Data
(60) Provisional application No. 63/209,600, filed on Jun. 11, 2021.

(51) Int. Cl. E05B 75/00; B65H 35/04; B65H 75/40; B65H 75/44

(52) U.S. Cl. CPC E05B 75/00; B65H 35/04; B65H 75/406; B65H 75/4431

(57) ABSTRACT

The quick physical restraint system has a binding, a dispenser, and a shield. The binding is deployed to wrap around a suspect to reduce the need to physically engage before placing the suspect into custody. The dispenser allows the binding to uncoil and be stored. The shield covers the binding to ensure it does not attach to the user. The binding has hooks, a latch and a binding handle. The hook is a metal spike along the binding length that is used to penetrate the suspects' clothing. The binding handle ensures the binding can be held without the dispenser. The dispenser has a binding spool, a binding cutter, a handle, a shield rail, a spool trigger, and a spool stopper. The binding spool is a cylindrical section that rolls out the binding. This design allows the binding to be deployed through the dispenser or used as a standalone device.

### FIELD OF THE INVENTION

The present invention relates generally to a quick physical restraint system. Further, the present invention is designed to allow police officers to apprehend suspects quickly, safely, and efficiently, without the need for excessive force and risk of serious injury.

### BACKGROUND OF THE INVENTION

The police force in the modern-day, experiences various encounters with individuals, some of whom do not comply with the instructions from the police officer. When some suspects become hostile, the police officer may be required to physically engage or wrestle with the suspect while taking the suspect into custody or placing hand cuffs on them. As police officers engage with various individuals, the difference in body size, height and strength can affect the method the officer uses to subdue the individual. This results in officers occasionally having to wrestle with the subject, utilizing a choke hold, taser, or other aggressive means of restraining the subject. These methods can harm and permanently injure the officer, or the individual being subdued, and some aggressive methods could otherwise be avoided with the present invention that allows the subject individual's arms and legs to be quickly immobilized without the need for excessive force.

### BRIEF DESCRIPTION OF THE DRAWINGS

FIG. 1 is a top perspective view of the present invention in the reusable (A) dispenser.

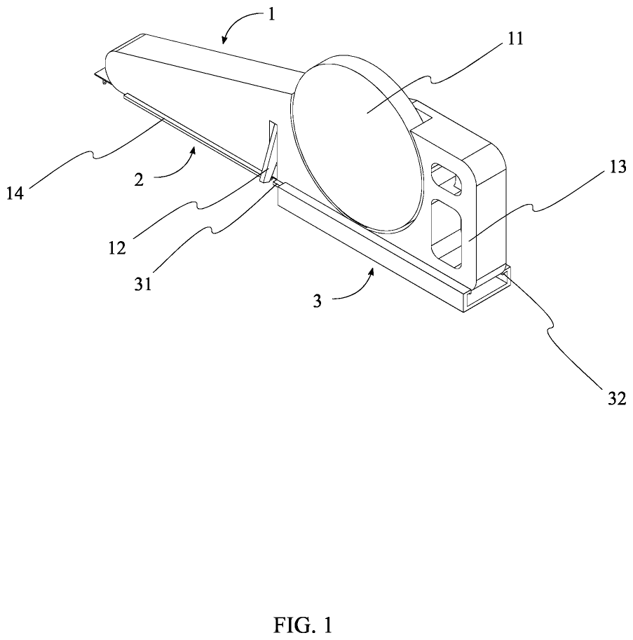

FIG. 2 is a bottom perspective view of the present invention in the reusable (A) dispenser.

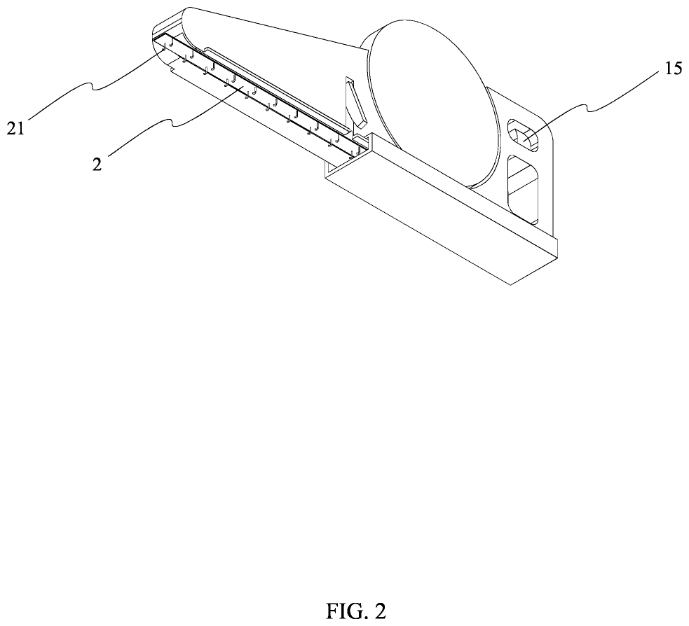

FIG. 3 is a front view of the present invention in the reusable (A) dispenser.

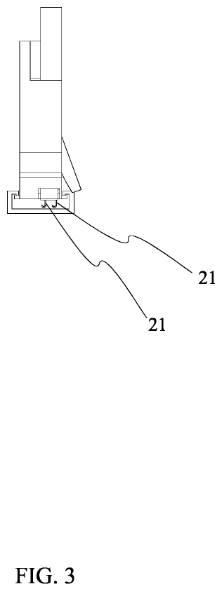

FIG. 4 is a rear view of the present invention in the reusable (A) dispenser.

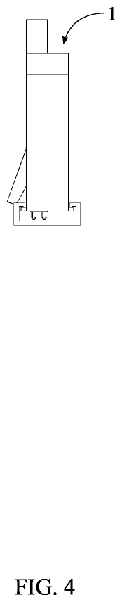

FIG. 5 is a right-side view of the present invention in the reusable (A) dispenser.

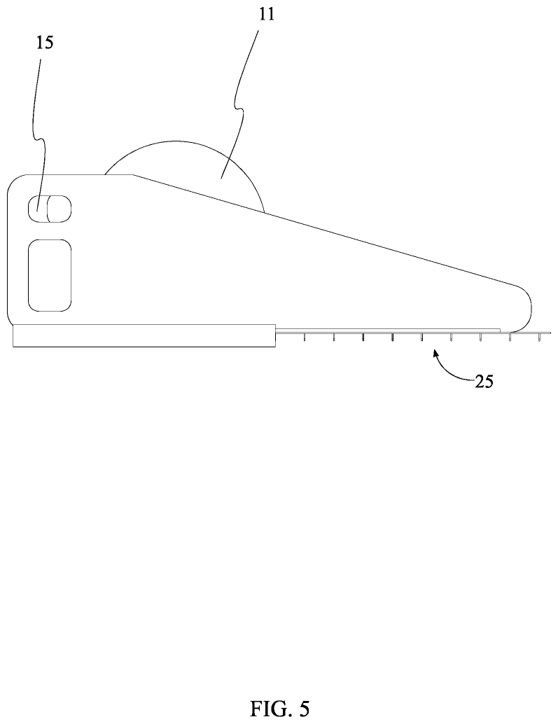

FIG. 6 is a left-side view of the present invention in the reusable A) dispenser.

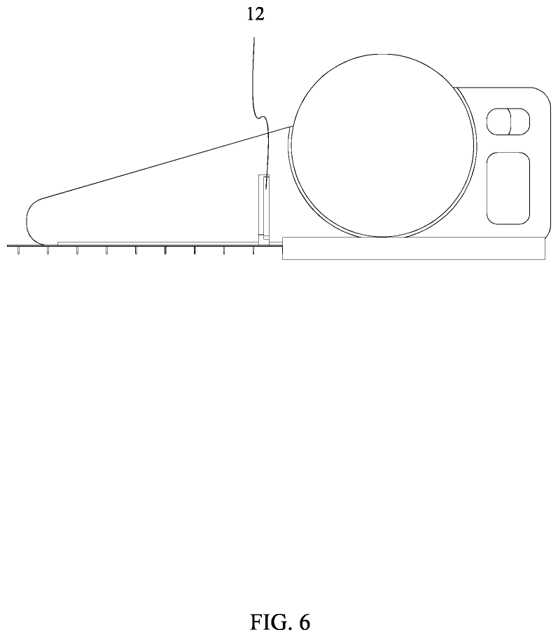

FIG. 7 is a top view of the present invention in the reusable (A) dispenser.

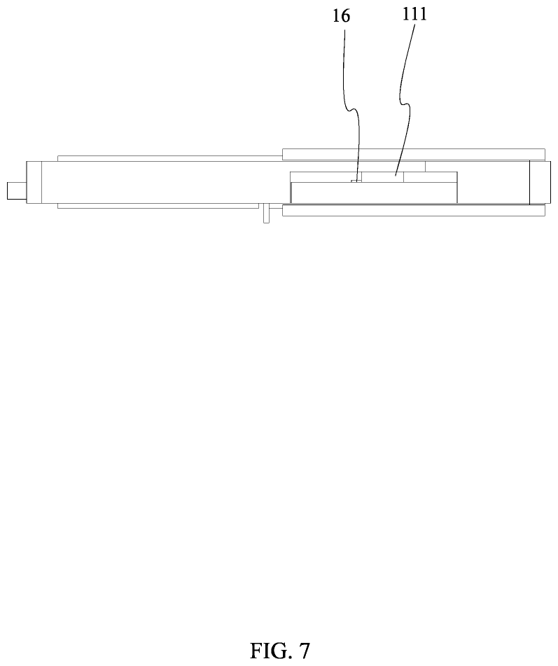

FIG. 8 is a bottom view of the present invention in the reusable (A) dispenser.

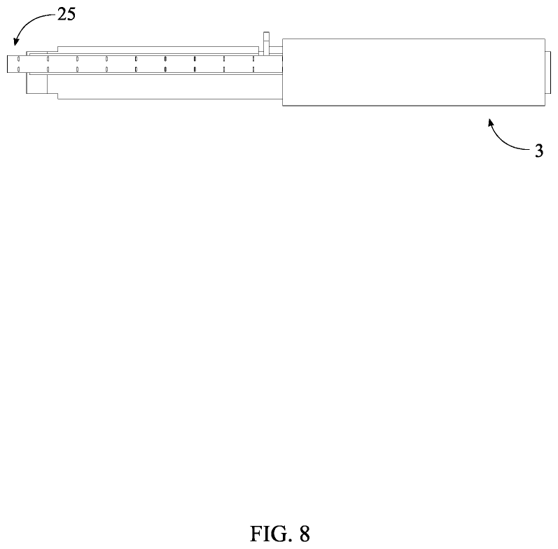

FIG. 9 is a top perspective view of the binding with the disposable (B) dispenser with the sheath off.

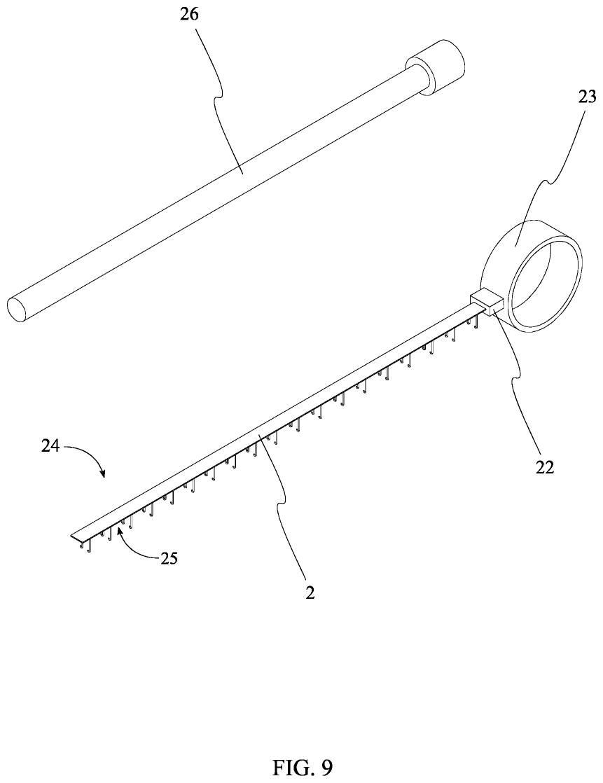

FIG. 10 is bottom perspective view of the binding in the disposable (B) dispenser with the sheath on.

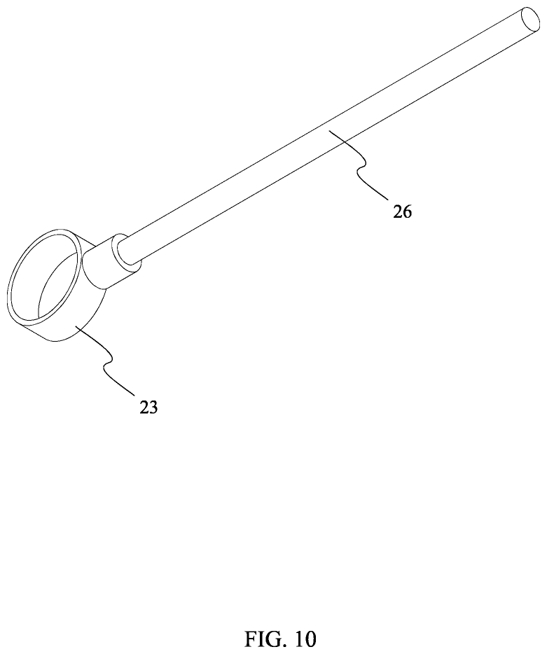

### DETAIL DESCRIPTIONS OF THE INVENTION

All illustrations of the drawings are for the purpose of describing selected versions of the present invention and are not intended to limit the scope of the present invention.

The binding 2 is a key component of the present invention. There are two optional deployment mechanisms for the binding 2: (A) a reusable configuration and (B) a disposable, one-time use configuration. The reusable (A) configuration is used by officers when multiple apprehensions are expected to occur during a short time period, such as a riot. The disposable (B) configuration will be used by officers on a daily basis, carried as a baton, when light weight, low cost, ease of use and quick availability are important.

The reusable (A) embodiment of the present invention comprises a binding 2, a dispenser body 1, and a shield 3. The binding 2 is a flexible nylon or metal strap material that can be coiled within the dispenser 1 and deployed to wrap around the body of a suspect. The reusable dispenser 1 is a mechanical system made of a lightweight plastic material that rotatably uncoils the binding 2 and can be further utilized as a baton. The shield 3 is a cover to protect the user from the binding 2 while the present invention is not in use. The binding 2 further comprises at least one barbed hook or rows of hooks 21. The hook 21 is a barbed metal spike that allows the binding 2 to penetrate and snag onto the suspects' clothing restraining their movement. The dispenser handle 13 is a component that allows a police officer to hold the dispenser in their hand. The dispenser 1 further comprises a binding spool 11, a binding cutter 12, a handle 13, a shield rail 14, and a spool trigger 15. The binding spool 11 is a cylindrical container that allows the binding 2 to be coiled within. The shield rail 14 is a notch in the dispenser 1 that allows the shield 3 to adjoin and slide horizontally along the dispenser 1. The spool trigger 15 is a mechanical device that limits the amount of binding deployed. The binding cutter 12 when pushed into the dispenser 1 cuts off the piece of binding that has been deployed. The shield 3 further comprises a shield latch 31 and rail notch 32. The shield latch 31 is the notch that secures the shield 3 over the open end of the dispenser 1. The rail notch 32 is a groove that traverses along the open end of the dispenser 1. The binding 2 is retained within the binding spool 11 of the dispenser 1. As a result, the binding 2 can be coiled within the binding spool 11 to be used in sections or all at once. The shield 3 is mounted adjacent to the shield rail 14 of the dispenser 1. Consequently, the shield 3 can move along the shield rail 14 to cover and uncover the binding 2 within the dispenser 1. The binding spool 11 is mounted to the dispenser 1 at the concentric center of the binding spool 11. Accordingly, the binding spool 11 can rotate around its concentric center allowing the binding 2 within, to uncurl and be dispensed. The binding cutter 12 is pivotably mounted along the dispenser 1. Thus, the binding cutter 12 can sever the excess binding 2 as it exits the dispenser 1. The handle 13 is terminally integrated into the dispenser 1. So, the handle 13 can be easily gripped by a police officer to control the dispenser 1. This further enables the dispenser 1 to be utilized as a crowd control device such as a baton. The binding spool 11 is mounted between the handle 13 and binding cutter 12. As a result, the binding spool 11 can easily interact with the binding cutter 12. The shield rail 14 is mounted on the periphery of the dispenser 1. As a result, the shield rail 14 allows the shield 3 to properly cover the open side of the dispenser 1. The spool trigger 15 is terminally integrated into the dispenser 1. Consequently, the spool trigger 15 can be easily utilized to control the spool stopper 16 as the binding 2 is uncoiled from the binding spool 11. The spool trigger 15 is positioned offset from the handle 13. Thus, the spool trigger 15 can be easily pulled or pushed into the dispenser 1 while the police officer grips the handle 13. The spool stopper 16 is integrated into the dispenser 1. So, the spool stopper 16 extends and retracts from the dispenser 1 sidewall. The spool stopper 16 is positioned offset from the binding spool 11. As a result, the spool stopper 16 interacts and halts the rotation of the binding spool as desired by the police officer. The spool stopper 16 is mechanically connected to the spool trigger 15. Consequently, the spool stopper 16 is controlled by the spool trigger 15 when it is either pushed or pulled into the dispenser 1.

Furthermore, the quick physical restraint system as described in the previous paragraph comprises a binding spool 11 that further comprises a rotating axle 111. The rotating axle 111 is a cylindrical rod. The rotating axle 111 is mounted concentrically to the binding spool 11. As a result, the binding spool 11 rotates around its concentric center via the rotating axle 111. The rotating axle 111 is rotatably connected to the dispenser 1. Consequently, the rotating axle 111 allows the binding spool 11 to rotate to either coil or uncoil the binding 2 within the binding spool 11 for storage or dispensing needs.

The present invention reusable (A) configuration covers the binding 2 stored within the binding spool 11 of the dispenser 1 via the shield 3. The dispenser latch 31 is terminally integrated into the shield 3. So, the dispenser latch 31 allows the shield 3 to be secured to the dispenser 1. Further, this shield covers the binding 2 and mitigates any potential accidents when the police officer is not using the present invention. The rail notch 32 traverses along the shield 3. As a result, the rail notch 32 allows the shield 3 to slide horizontally along the open side of the dispenser 1.

In the reusable (A) embodiment, the shield 3 of the quick physical restraint system is positioned offset from the suspect-facing surface 25 of the binding 2. Consequently, the shield 3 covers the suspect-facing surface 25 of the binding 2 ensuring the binding 2 only adheres to clothing when intended by the police officer utilizing the present invention.

Optionally, the present invention offers a disposable (B) dispenser configuration that comprises a binding 2 portion, approximately 24 inches long, that can be utilized independently. The binding 2 further comprises a suspect-facing surface 25 and a user-facing surface 24. The suspect-facing surface 25 is used to apprehend the suspect and secure the binding 2 around the body of the suspect. The user-facing surface 24 is a flat surface. In the disposable (B) configuration, the binding is initially equipped with a removable tubular sheath 26 which ensures the police officer does not get caught by the binding 2. At least one barbed hook 21 or multiple rows of barbed hooks, is mounted along the suspect-facing surface 25. As a result, the hook or hooks 21 enables the suspect-facing surface 25 of the binding 2 to pierce the clothing of the suspect. The latch 22 is terminally connected to the binding 2 at one end. Consequently, the latch 22 creates a connection and attachment allowing the binding 2 to be secured within the sheath 26 of equal length. The binding handle 23 is mounted to the latch 22 which is connected to one end of the binding 2. Accordingly, the binding handle 23 allows the binding 2 to be gripped by the police officer and utilized independently from the sheath 26.

Although the invention has been explained in relation to its preferred embodiments, it is to be understood that many other possible modifications and variations can be made without departing from the spirit and scope of the invention as hereinafter claimed.

1. A quick physical restraint system comprising:
a binding;
one of two types of dispenser;
a shield or sheath;
the binding comprising at least one barbed hook, or rows of hooks; and
a dispenser handle.

2. A quick physical restraint device with a reusable (A) dispenser comprising:
a binding spool;
a binding cutter;
a handle;
a shield rail;
and a spool trigger;
the shield comprising a shield latch and rail notch;
a binding being retained within the binding spool of the dispenser;
the shield being mounted adjacent to the shield rail of the dispenser;
the binding spool being mounted to the dispenser at the concentric center of the binding spool;
the binding cutter being pivotably mounted along the dispenser;
the handle being terminally integrated into the dispenser; and
the binding spool being mounted between the handle and binding cutter.

3. The quick physical restraint system as claimed in claim 2, the shield rail being mounted on the periphery of the dispenser.

4. The quick physical restraint system as claimed in claim 2 comprising:
the spool trigger being terminally integrated into the dispenser; and
the spool trigger being positioned offset from the handle.

5. The quick physical restraint system as claimed in claim 2 comprising:
the spool stopper being integrated into the dispenser;
the spool stopper being positioned offset from the binding spool; and
the spool stopper being mechanically connected to the spool trigger.

6. The quick physical restraint system as claimed in claim 2 comprising:
the binding spool comprising a rotating axle;
the rotating axle being mounted concentrically to the binding spool; and
the rotating axle being rotatably connected to the dispenser.

7. The quick physical restraint system as claimed in claim 2 comprising:
the binding comprising a suspect-facing surface and a user-facing surface; and
at least one barbed hook or several rows of hooks, being mounted along the suspect-facing surface.

8. The quick physical restraint system as claimed in claim 7, comprising:
at least one hook comprising a hook notch or barb; and
the hook notch being terminally mounted to the hook.

9. The quick physical restraint system as claimed in claim 2 comprising:
the binding being retained within the binding spool of the dispenser;
the binding spool being mounted to the dispenser at the concentric center of the binding spool;
the binding cutter being pivotably mounted along the dispenser;
the handle being terminally integrated into the dispenser; and
the binding spool being mounted between the handle and binding cutter.

10. (canceled)

11. (canceled)

12. (canceled)

13. (canceled)

14. The quick physical restraint system as claimed in claim 2 comprising:
the dispenser latch being terminally integrated into the shield; and
the rail notch traversing along the shield.

15. The quick physical restraint system as claimed in claim 1 comprising:
a (B) configuration of the dispenser employing a latch being terminally integrated into the sheath.

16. The quick physical restraint system as claimed in claim 15, wherein a tubular sheath encloses a piece of binding with suspect-facing hooks, the quick physical restraint system comprising a (B) dispenser sheath configuration dispenser comprising:
a binding; and
a sheath containing a piece of binding comprising at least one barbed hook, a latch and a binding handle.

17. The quick physical restraint system configuration (B) as claimed in claim 16 comprising:
the binding comprising a suspect-facing surface and a user-facing surface;
at least one barbed hook or rows of hooks, being mounted along the suspect-facing surface;
the latch being terminally connected to the binding joining the sheath; and
the binding handle being mounted to one end of the binding.

18. The quick physical restraint system as claimed in claim 1, the binding being a flexible nylon or metal material of various length.

19. The quick physical restraint system binding as claimed in claim 17, comprising:
at least one hook comprising a hook notch or barb; and
the hook notch being terminally mounted to the hook.
